(19) United States
(12) Patent Application Publication
(10) Pub. No.: US 2005/0259037 A1
(43) Pub. Date: Nov. 24, 2005

(54) Alternating current plasma display panel

(75) Inventors: Shou-Ling Sui, Bade City (TW); Yao-Ching Su, Taoyuan City (TW); Yi-Jen Wu, Longtan Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/053,140

(22) Filed: Feb. 8, 2005

(30) Foreign Application Priority Data
May 20, 2004 (TW) 93114222

(51) Int. Cl. G09G 3/28

(52) U.S. Cl. 345/60

(57) ABSTRACT

A closed type AC plasma display panel. A first substrate and a second substrate are provided with a predetermined gap therebetween. Barrier ribs are interposed between the first substrate and the second substrate. The barrier ribs define a plurality sets of a first, a second and a third discharge cell. A plurality of address electrodes is formed on the first substrate in the first, the second, and the third discharge cells along a first direction, and a plurality of sustain electrodes formed on the second substrate in the first, the second, and the third discharge cells along a second direction, wherein each area of the sustain electrodes are substantially equal and at least one area of the address electrodes is different from others area of the address electrodes in the first, the second, and the third discharge cells.

### FIELD OF THE INVENTION

The present invention relates to a plasma display panel. More particularly, the present invention relates to a closed cell type alternating current (AC) plasma display panel capable of improving the address margin.

### BACKGROUND OF THE INVENTION

Plasma display panels (PDPs) are classified depending on how the discharge cells thereof are arranged. Two main types of PDPs are strip PDPs, in which gas discharge spaces are arranged in a strip pattern, and closed cell PDPs, in which individual cells are defined by enclosed partition barrier ribs.

Referring to FIG. 1A, the conventional AC plasma display panel 80 is provided with a front substrate 82 and a rear substrate 83 opposing each other and separated by a discharge space. A plurality of pairs of strip scanning electrodes 86 and sustaining electrodes 87 are arranged substantially in parallel and covered with a dielectric layer 84 and a protective coating 85 on the front substrate 82. A plurality of strip address electrodes 88 are formed substantially in parallel on the rear substrate 83 in the direction perpendicular to the scanning electrode 86 and the sustaining electrode 87. Strip barriers 89 are arranged between the address electrodes 88. Phosphors 90 are formed between the barriers 89 and on the sidewalls of the barriers so as to cover the address electrodes 88. Spaces surrounded by the surface substrate 82, the rear substrate 83 and the barriers 89 form discharge cells 91. The spaces in the discharge cells 91 are filled with gases radiating ultraviolet light due to discharge.

Referring to FIG. 1B, the phosphor 90 comprises a blue phosphor 90b, a green phosphor 90g and a red phosphor 90r, one of which is formed in each discharge cell. Thus, the discharge cell provided with the blue phosphor 90b constitutes a blue discharge cell 91b, the discharge cell provided with the green phosphor 90g constitutes a green discharge cell 91g, and the discharge cell provided with the red phosphor 90r constitutes a red discharge cell 91r.

The above-described configuration, however, has a problem in that the discharge starting voltage of the green discharge cell 91g is different from that of the other two discharge cells 91b and 91r. FIG. 1C shows write voltages necessary to perform a write discharge in a stable manner when a constant voltage is applied to the scanning electrodes 86 in the write operation in the address period (complete lighting write voltages) with respect to the discharge cells of respective colors. As described above, in the conventional panel, the discharge cells have write voltages that differ from color to color. As a result, as is clearly shown in FIG. 1C, the discharge cells have complete lighting write voltages that are considerably different depending on their colors. Thus, applying the same write voltage to all the discharge cells can cause unstable write discharge, erroneous discharge or discharge flicker, leading to improper display.

In order to perform a stable write operation, the write voltage applied to the address electrodes 88 must change depending on the colors of the discharge cells in accordance with the complete lighting write voltage of the discharge cells of respective colors. This complicates the voltage control, however, and increase the cost of the apparatus.

### SUMMARY OF THE INVENTION

Embodiments of the invention provide a cell structure for an AC plasma display panel with equivalent complete lighting write voltages of the R, G, and B discharge cells to improve the address margin of the panel.

Embodiments of the present invention further provide different addressing electrode areas of respective colors for an AC plasma display panel with equivalent complete lighting write voltages of the discharge cells to improve the address margin of the panel.

To achieve these and other advantages, embodiments of the invention provide a closed cell type AC plasma display panel, comprising a first substrate and a second substrate opposing the first substrate. The first substrate and the second substrate are provided with a predetermined gap therebetween. Barrier ribs are interposed between the first substrate and the second substrate. The barrier ribs define a plurality sets of a first, a second and a third discharge cell. A plurality of address electrodes are formed on the first substrate in the first, the second, and the third discharge cells along a first direction. A plurality of sustain electrodes are formed on the second substrate in the first, the second, and the third discharge cells along a second direction, wherein each area of the sustain electrodes in the first, the second, and the third discharge cells are substantially equal, and at least one area of the address electrodes in the first, the second, and the third discharge cells is different from other areas of the address electrodes in the first, the second, and the third discharge cells.

It is understood that the first, the second and the third discharge cell sets corresponding to the first color, the second color, and the third color, and the discharge cells sets can be arranged in triangular shape. Each of the present individual discharge spaces is formed in a quadrangular shape or hexagonal shape.

### BRIEF DESCRIPTION OF THE DRAWINGS

The present invention can be more fully understood by reading the subsequent detailed description in conjunction with the examples and references made to the accompanying drawings, wherein:

FIG. 1A is a partially cutaway perspective view illustrating a schematic configuration of a conventional AC type plasma display panel;

FIG. 1B is a cross section of FIG. 1A taken along the line B-B in the direction indicated by the arrow;

FIG. 1C shows write voltages necessary to perform a write discharge in a stable manner;

FIG. 2A is a schematic front view of rear substrate of an AC type plasma display panel according to the first embodiment of the present invention;

FIG. 2B is a cross section of FIG. 2A taken along the line V-V in the direction indicated by the arrow;

FIGS. 2C and 2D show the shape of large electrode portions of address electrode according to the first embodiment of the present invention;

FIG. 3 is schematic front view of the second substrate of an AC plasma display panel according to the second embodiment of the present invention; and

FIG. 4 is a schematic front view of rear substrate of an AC plasma display panel according to the third embodiment of the present invention.

### DETAILED DESCRIPTION

### First Embodiment

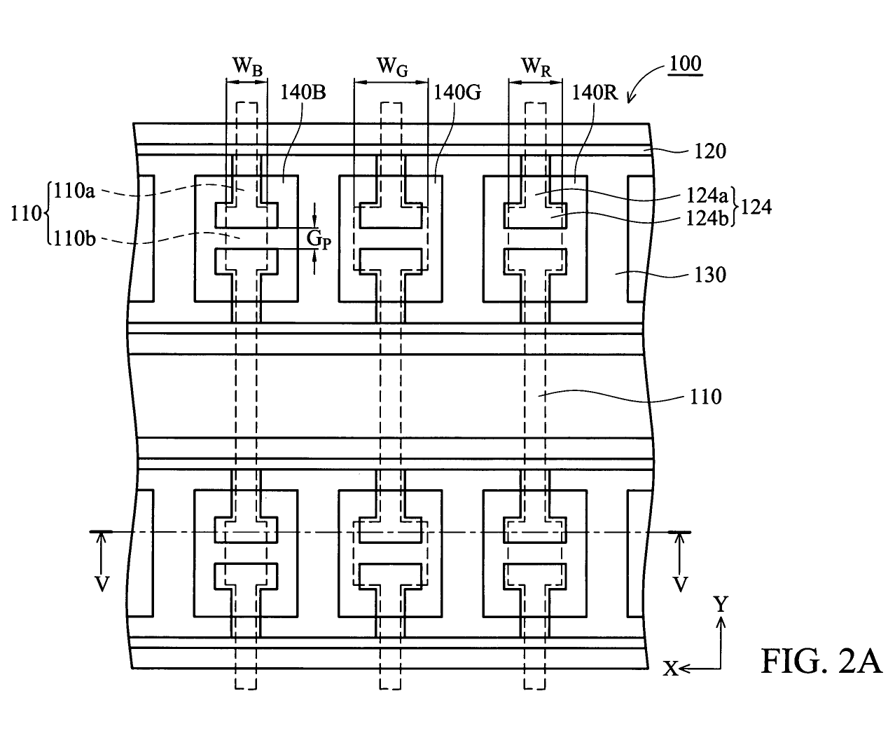

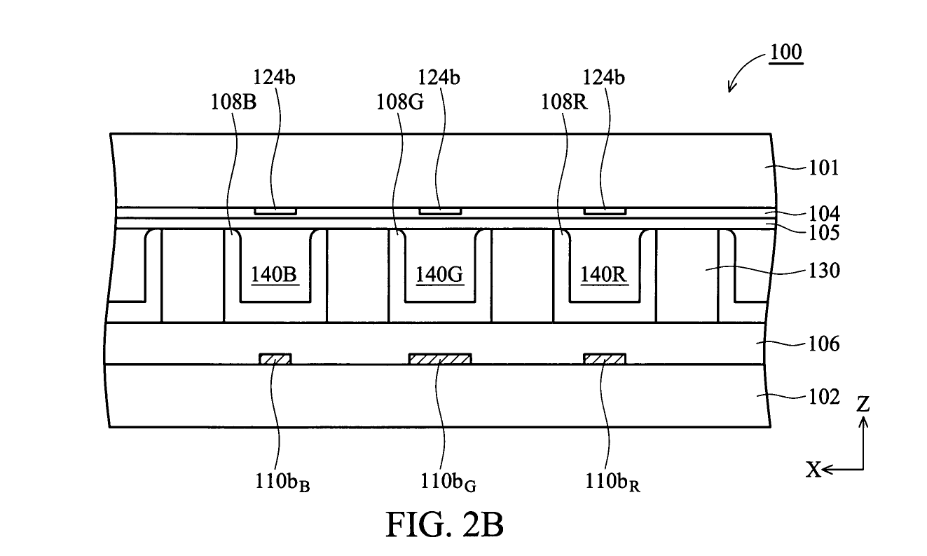

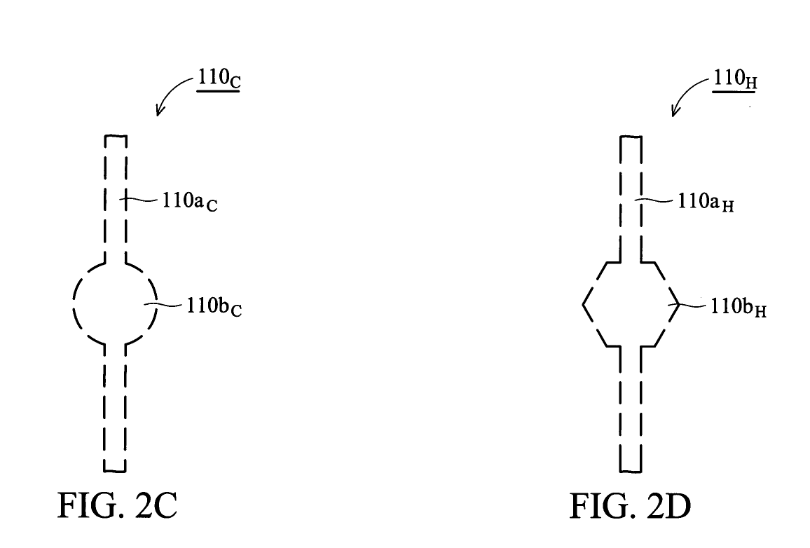

The embodiment of the invention provides a closed cell type AC plasma display panel. FIGS. 2A to 2D illustrate the first embodiment of the closed cell type AC plasma display panel. In a plasma display panel (PDP) according to a first embodiment of the present invention, a plurality of discharge cell sets comprising R, G, and B colors are defined by barrier ribs partition, each set a substantially along the first direction (X) to forming a closed type PDP. Each discharge cell is independently controlled to display predetermined images.

Referring to FIG. 2A, the PDP 100 includes a first substrate 102 (also known as a rear substrate) and a second substrate 101 (also known as a front substrate). Rear substrate 102 and front substrate 101 are disposed substantially in parallel with a predetermined gap therebetween.

Barrier ribs 130 are disposed at a predetermined height between rear substrate 102 and front substrate 101 in a ladder-shaped pattern along the first direction (X). Barrier ribs 130 define a plurality of discharge spaces 140R, 140G, and 140B. In the present embodiment of the invention, each set of discharge spaces 140R, 140G, and 140B is arranged substantially in a first direction, while each of the individual discharge spaces 140R, 140G, and 140B is formed in a quadrangular shape.

A plurality of address electrodes 110 is formed on rear substrate 102 along the second direction (Y). Address electrodes 110 are formed both within and outside of discharge spaces 140R, 140G, and 140B. Also, a first dielectric layer 106 is formed over the surface of rear substrate 102 covering address electrodes 110.

The address electrodes 110 include small electrode portions 110a in Y direction, and large electrode portions 110b formed within discharge spaces 140R, 140G, and 140B. The widths of the large electrode portions 10b vary with different discharge spaces 140R, 140G, and 140B and denote as W_{R}, W_{G}, W_{B}, respectively.

A plurality of sustain electrodes 120 are formed on front substrate 101 along direction X. Sustain electrodes 120 include main electrode portions 120, which are positioned corresponding to portions of barrier ribs 130 extending along direction X, and branch electrode portions 124, extending from main electrode portions 120 into areas corresponding to formation of discharge spaces 140R, 140G, and 140B. Two branch electrode portions 124 extend from two main electrode portions 120 of different sustain electrodes in each discharge space 140R, 140G, and 140B. Branch electrode portions 124 include first electrode portion 124a that extends perpendicularly from main electrode portions 120, and second electrode portion 124b that enlarges on a distal end of first electrode portion 124a extending parallel to the main electrode portions 120. Within one discharge space, a gap G_{P} is formed between two second electrode portions 124b extending into discharge space from opposite directions, that is, from two different main electrode portions 120.

In the present embodiment, a bus electrode can be formed on the main electrode portions 120. The bus electrode comprises an opaque material, such as Ag metal or like, and the sustain electrodes 120 comprise a transparent material, such as indium tin oxide (ITO) or like. Referring to FIG. 2B, transparent second dielectric layer 104 is formed over front substrate 101 covering sustain electrodes 120. Additionally, protective layer 105 comprising MgO or like is formed over second dielectric layer 104.

Phosphor layers 108R, 108G, and 108B are formed in discharge spaces 140R, 140G, and 140B, respectively. Phosphor layers 108R, 108G, and 108B cover first dielectric layer 106 and are formed extending up the side-walls of barrier ribs 130. In present embodiment, BaMgAl₁₀O₁₇:Eu is used as the blue phosphor 108B, Zn₂SO₄:Mn is used as the green phosphor 108G, and (Y₂Gd)BO₃:Eu is used as the blue phosphor 108B.

In FIG. 2A, address electrodes 110 include large electrode portions 110b positioned in discharge spaces 140R, 140G, and 140B, and small electrode portions 110a are positioned under barrier ribs 130 between discharge spaces 140R, 140G, and 140B. Large electrode portions 110b have widths W_{R}, W_{G}, and W_{B} that are greater than widths of the small electrode portions 110a.

The widths W_{R}, W_{G}, and W_{B} are made different depending on the material properties of the R, G, and B phosphor layers 140R, 140G, and 140B. In present embodiment of the invention, widths W_{R}, W_{G}, and W_{B} of large electrode portions 110b for the R. G, and B pixels, respectively, satisfy the following condition.
W_{B}≦W_{R}≦W_{G}.

The width W_{G} of the large electrode portion 110b for the G pixel is made larger than the widths W_{R} and W_{B} of large electrode portions 10b for the R pixel and the G pixel, respectively, due to the creation of wall discharges on the phosphor layers by application of the write voltage during an address period. The creation of wall charges determines lighting of discharge cells in a sustaining period. As such, the write voltage of G phosphor layer 108G exceeds the write voltages of R and B phosphor layers 108R and 108B. More specifically, by varying the widths W_{R}, W_{G}, and W_{B} of large electrode portions 10b, the address margins of the R, G, and B pixels can be improved.

The shape of large electrode portions 10b of address electrodes 110 is not limited to a quadrangular shape and can be formed in a circular shape 110b_{C} as shown in FIG. 2C, and various polygonal shapes such as a hexagonal shape 110b_{H} as shown in FIG. 2D.

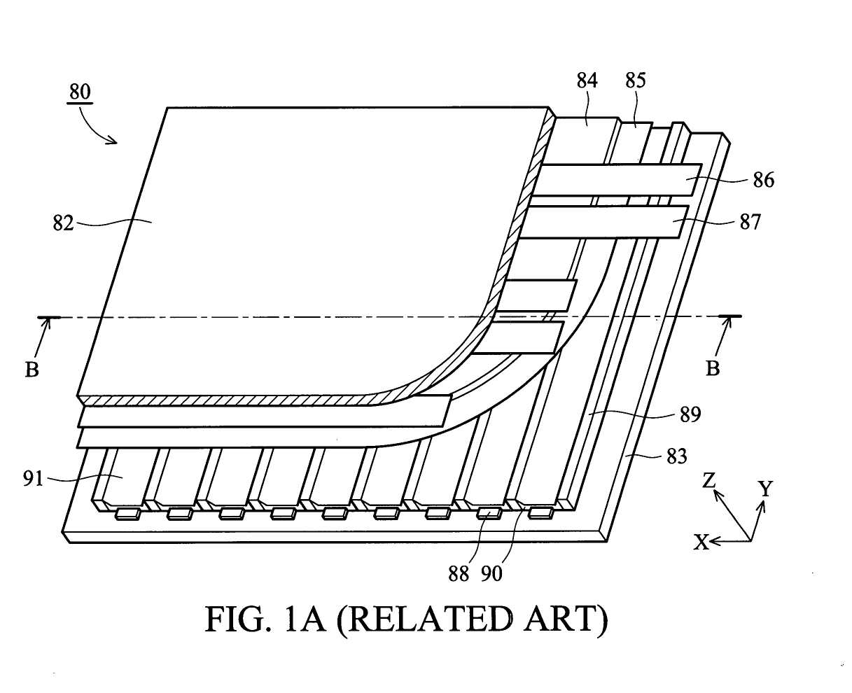

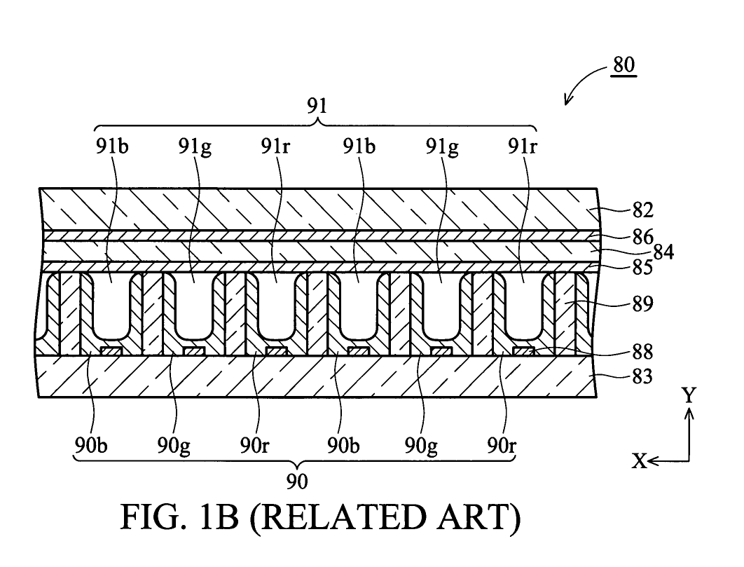

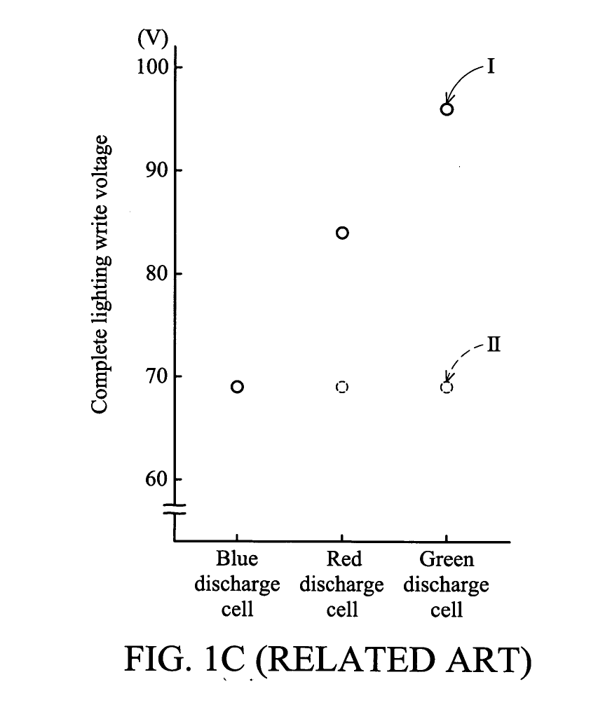

In the present embodiment, since discharge cells of all colors have substantially the same complete lighting write voltages, with increased address margins, write operations among the discharge cells of all colors during sustaining period are uniform, thus preventing display flickering, erroneous write operations and improving the address margins and voltage margins during the sustaining period in the panel. This indicates that a stable write operation (address operation) can be achieved as shown in FIG. 1C (dotted line II). Furthermore, the minimum voltage necessary for writing to the discharge cells of respective colors is considerably lower compared with that necessary for the conventional panel. Thus, a low-cost integrated circuit (IC) can be used for a write pulse generating circuit.

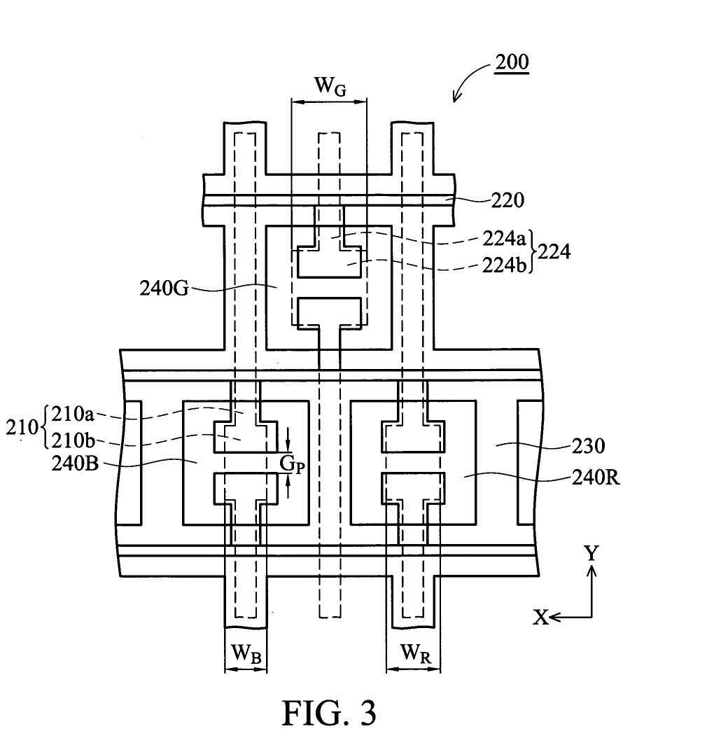

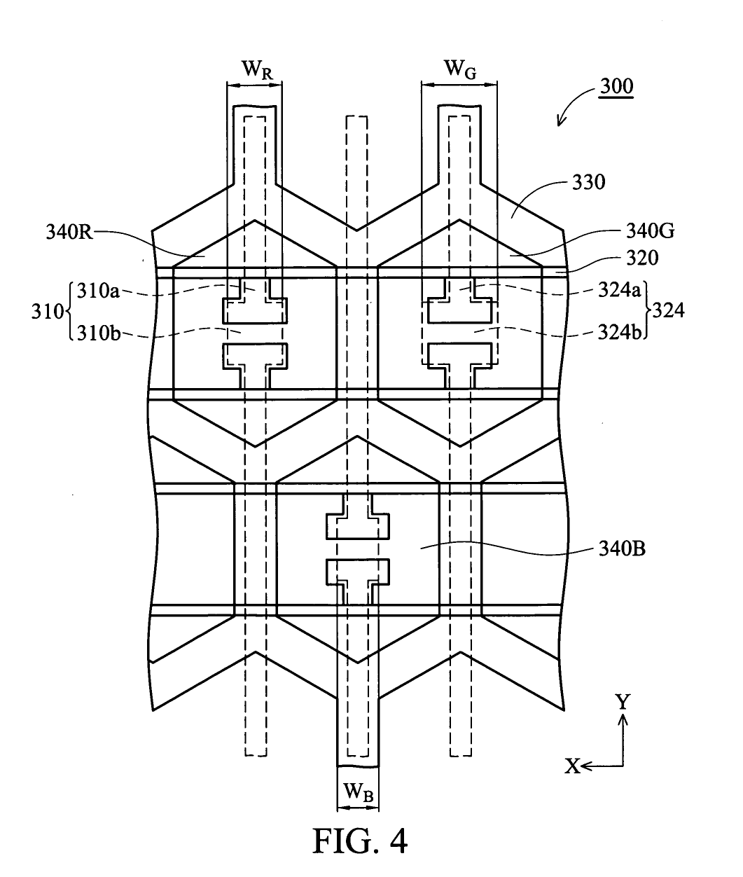

The configurations of discharge cells R, G, and B of present embodiments of the invention are not limited to a linear sequence and can be formed in triangular arrangement, while each of the individual discharge spaces R, G, and B is formed in a quadrangular shape as shown in FIG. 3, and various polygonal shapes such as a hexagonal shape in an overall structure of a honeycomb as shown in FIG. 4.

### Second Embodiment

A plurality of discharge cells 240R, 240G, 240B are defined by sets of barrier ribs, each set forming a substantially triangular arrangement (i.e., delta-nabla structure) sequence to realize a closed type PDP. Each discharge cell is independently controlled to display predetermined images, and each discharge cell is quadrangular shape.

Referring to FIG. 3, address electrodes 210 include large electrode portions 210b that are positioned in discharge spaces 240R, 240G, and 240B, and small electrode portions 210a positioned under barrier ribs 130 between discharge spaces 240R, 240G, and 240B. Large electrode portions 210b have widths W_{R}, W_{G}, and W_{B} greater than widths W_{R}, W_{G}, and W_{B} of small electrode portions 210a.

Branch electrode portions 224 include first electrode portion 224a that extends perpendicularly from main electrode portions 220, and second electrode portion 224b that enlarges on a distal end of first electrode portion 224a to extend parallel to main electrode portions 220. Within one discharge space, a gap G_{P} is formed between two second electrode portions 224b extending into the discharge space from opposite directions, that is, from two different main electrode portions 220.

The widths W_{R}, W_{G}, and W_{B} are made different depending on the material properties of the R, G, B phosphor layers 240R, 240G, and 240B. In the present embodiment of the invention, the widths W_{R}, W_{G}, and W_{B} of large electrode portions 210b for the R, G, and B pixels, respectively, satisfy the following condition.
W_{B}≦W_{R}≦W_{G}.

The width W_{G} of the large electrode portion 210b for the G pixel is made larger than widths W_{R} and W_{B} of large electrode portions 210b for the R pixel and the B pixel, respectively, due to the creation of wall discharges on the phosphor layers by application of the write voltage during the address period. The creation of wall charges determines the lighting of discharge cells in the sustaining period. As such, the write voltage of G phosphor layer exceeds the write voltages of R and B phosphor layers. More specifically, by varying the widths W_{R}, W_{G}, and W_{B} of large electrode portions 110b, the address margins of the R, G, and B pixels can be improved.

The shape of large electrode portions 110b of address electrodes 110 is not limited to a quadrangular shape and can be formed in a circular shape 110b_{C} as shown in FIG. 2C, and various polygonal shapes such as a hexagonal shape 110b_{H} as shown in FIG. 2D.

In the present embodiment, since discharge cells of all colors have substantially the same complete lighting write voltages, with increased address margins, write operations among the discharge cells of all colors during the sustaining period are uniformed, thus preventing display flickering, erroneous write operations, and improving address margins and voltage margins during the sustaining period in the panel. This indicates that a stable write operation (address operation) can be achieved as shown in FIG. 1C (dotted line II). Furthermore, the minimum voltage necessary for writing to the discharge cells of respective colors is considerably lower compared with that necessary for the conventional panel. Thus, a low-cost IC can be used for a write pulse generating circuit.

### Third Embodiment

A plurality of discharge cells 340R, 340G, 340B are defined by sets of barrier ribs, each set forming a substantially hexagonal (i.e., honeycomb structure) sequence to realize a closed type PDP. Each discharge cell is independently controlled to display predetermined images.

Referring to FIG. 4, address electrodes 310 include large electrode portions 310b that are positioned in discharge spaces 340R, 340G, and 340B, and small electrode portions 310a positioned under barrier ribs 330 between discharge spaces 340R, 340G, and 340B. Large electrode portions 310b have widths W_{R}, W_{G}, and W_{B} greater than widths of small electrode portions 310a.

Branch electrode portions 324 include first electrode portion 324a that extends perpendicularly from main electrode portions 320, and second electrode portion 324b that enlarges on a distal end of first electrode portion 324a to extend parallel to main electrode portions 320. Within one discharge space, a gap G_{P} is formed between two second electrode portions 324b extending into the discharge space from opposite directions, that is, from two different main electrode portions 320.

The widths W_{R}, W_{G}, and W_{B} are made different depending on the material properties of the red (R), green (G), and blue (B) phosphor layers 340R, 340G, and 340B. In the present embodiment of the invention, the widths W_{R}, W_{G}, and W_{B} of the large electrode portions 310b for the R, G, and B pixels, respectively, satisfy the following condition.
W_{B}≦W_{R}≦W_{G}.

The width W_{G} of the large electrode portion 310b for the G pixel is made larger than widths W_{R} and W_{B} of large electrode portions 310b for the R pixel and the B pixel, respectively, due to the creation of wall discharges on the phosphor layers by application of the write voltage during an address period. The creation of wall charges determines the lighting of discharge cells in the sustaining period. As such, the write voltage of G phosphor layer exceeds the write voltages of R and B phosphor layers. More specifically, by varying the widths W_{R}, W_{G}, and W_{B} of large electrode portions 310b, the address margins of the R, G, and B pixels can be improved.

The shape of large electrode portions. 110b of address electrodes 110 is not limited to a quadrangular shape and can be formed in a circular shape 110b_{C} as shown in FIG. 2C, and various polygonal shapes such as a hexagonal shape 110b_{H} as shown in FIG. 2D.

In present embodiment, since discharge cells of all colors have substantially the same complete lighting write voltages, with increased address margins, write operations among the discharge cells of all colors during sustaining period are uniform, thus preventing display flickering, erroneous write operations, and improving the address margins and voltage margins during the sustaining period in the panel. This indicates that a stable write operation (address operation) can be achieved as shown in FIG. 1C (dotted line II). Furthermore, the minimum voltage necessary for writing to the discharge cells of respective colors is considerably lower compared with that necessary for the conventional panel. Thus, a low cost IC can be used for a write pulse generating circuit.

While the invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives, which have been discussed above, and all equivalents thereto.

1. A plasma display panel comprising:
a first substrate;
a second substrate opposing the first substrate;
a plurality of barrier ribs interposed between the first substrate and the second substrate, the barrier ribs defining a plurality sets of a first, a second and a third discharge cell;
a plurality of address electrodes formed on the first substrate in the first, the second, and the third discharge cells along a first direction;
wherein an area of the address electrodes in the first discharge cell is different from each area of the address electrodes in the second and the third discharge cells; and
a plurality of sustain electrodes formed on the second substrate in the first, the second, and the third discharge cells along a second direction;
wherein each area of the sustain electrodes in the first, the second, and the third discharge cells are substantially equal.

2. The plasma display panel of claim 1, wherein each set of the first, the second, and the third discharge cells being sequentially arranged along the second direction.

3. The plasma display panel of claim 1, wherein each set of the first, the second, and the third discharge cells are arranged in a triangular shape.

4. The plasma display panel of claim 3, wherein each set of the first, the second, and the third discharge cells is quadrangular.

5. The plasma display panel of claim 3, wherein each set of the first, the second, and the third discharge cells is hexagonal.

6. The plasma display panel of claim 1, wherein each of the sustain electrodes comprises:
a plurality of main electrode portions provided along the first direction; and
a plurality of branch electrode portions formed extending from the main electrode portions and positioned within the first, the second, and the third discharge cells.

7. A plasma display panel, comprising:
a first substrate;
a second substrate opposing the first substrate;
a plurality of barrier ribs interposed between the first substrate and the second substrate, the barrier ribs defining a plurality sets of a first, a second and a third discharge cell;
a plurality of address electrodes formed on the first substrate in the first, and the second discharge cells along a first direction;
wherein the first discharge cell requires a first complete lighting write voltage, the second discharge cell requires a second complete lighting write voltage, and the first complete lighting write voltage exceeds the second complete lighting write voltage, and an area of the address electrodes in the first discharge cell substantially exceeds an area of the address electrodes in the second discharge cells; and
a plurality of sustain electrodes formed on the second substrate in the first, and the second discharge cells along a second direction;
wherein each area of the sustain electrodes in the first, and the second discharge cells are substantially equal.

8. The plasma display panel of claim 7, wherein each set of the first, the second, and the third discharge cells being sequentially arranged along the second direction.

9. The plasma display panel of claim 7, wherein each set of the first, the second, and the third discharge cells are arranged in a triangular shape.

10. The plasma display panel of claim 9, wherein each set of the first, the second, and the third discharge cells is quadrangular.

11. The plasma display panel of claim 9, wherein each set of the first, the second, and the third discharge cells is hexagonal.

12. The plasma display panel of claim 7, wherein each of the sustain electrodes comprises:
a plurality of main electrode portions provided along the first direction; and
a plurality of branch electrode portions formed extending from the main electrode portions and positioned within the first, the second, and the third discharge cells.

13. A plasma display panel comprising:
a first substrate;
a second substrate opposing the first substrate;
a plurality sets of red (R), green (G), and blue (B) discharge cells disposed between the first substrate and the second substrate and enclosed by a barrier rib;
a plurality of address electrodes formed on the first substrate in the R, G, and B discharge cells along a first direction;
wherein an area of the address electrodes in the R discharge cell is different from each area of the address electrodes in the G and B discharge cells; and
a plurality of sustain electrodes formed on the second substrate in the R, G, and B discharge cells along a second direction;
wherein each area of the sustain electrodes in the R, G, and B discharge cells are substantially equal.

14. The plasma display panel of claim 13, wherein each set of the R, G, and B discharge cells being sequentially arranged along the second direction.

15. The plasma display panel of claim 13, wherein each set of the R, G, and B discharge cells are arranged in a triangular shape.

16. The plasma display panel of claim 15, wherein each set of the R, G, and B discharge cells is quadrangular.

17. The plasma display panel of claim 15, wherein each set of the R, G, and B discharge cells is hexagonal.

18. The plasma display panel of claim 13, wherein each of the sustain electrodes comprises:
a plurality of main electrode portions provided along the first direction; and
a plurality of branch electrode portions formed extending from the main electrode portions and positioned within the R, G, and B discharge cells.

19. The plasma display panel of claim 13, wherein the width of the address electrodes in the B discharge cell is substantially equal to or less than the width of the address electrodes in the R discharge cell and substantially equal to or less than the width of the address electrodes in the G discharge cell.
